(19) United States
(12) Patent Application Publication
(10) Pub. No.: US 2023/0237035 A1
(43) Pub. Date: Jul. 27, 2023

(54) Fast Skip-List Scan and Insert

(71) Applicant: Salesforce, Inc., San Francisco, CA (US)

(72) Inventors: Patrick James Helland, San Rafael, CA (US); James E. Mace, San Francisco, CA (US)

(21) Appl. No.: 17/938,078

(22) Filed: Oct. 5, 2022

Related U.S. Application Data
(60) Provisional application No. 63/267,089, filed on Jan. 24, 2022.

(51) Int. Cl. G06F 16/22

(52) U.S. Cl. CPC G06F 16/2272; G06F 16/2255

(57) ABSTRACT

Techniques are disclosed relating to efficiently managing skip list data structures. In various embodiments, a computing system stores a skip list including a plurality of key-value records that include one or more pointers to others of the plurality of key-value records. The computing system scans the skip list for a location associated with a particular key. The scanning includes using a prefix of the particular key to identify a particular portion of the skip list, where the particular portion includes key-value records having keys with the same prefix. The scanning also further includes initiating a scan for the location within the identified portion. In some embodiments, the computing system inserts a key-value record into the skip list at the location associated with the particular key in response to the scan identifying the location.

The present application claims priority to U.S. Prov. App. No. 63/267,089, entitled “Fast Skip-List Scanning,” filed Jan. 24, 2022, which is incorporated by reference herein in its entirety.

### BACKGROUND

### Technical Field

This disclosure relates generally to data storage, and, more specifically, to manipulating a skip list data structure.

### Description of the Related Art

In the computer science field, various complex data structures have been developed to facilitate the storage of information. These data structures are often created using multiple pointers to join a collection of records together. When designing a complex structure, a developer is often weighing concerns related to the complexities of inserting and retrieving information as well as the overall data structure size. A skip list is one example of a more complex data structure, which can be popular as it can maintain large data sets while still offering up to O(log n) insertion complexity and up to O(log n) search complexity. In this type of data structure, records may be sorted based on key order and associated using a linked hierarchy of data record sequences, with each successive sequence skipping over fewer elements than the previous sequence. This linked hierarchy is implemented using varying heights of pointer towers such that, within a given a tower, pointers may be arranged based on the numbers of skipped-over records. This ability to skip over records when the skip list is traversed may allow a given record to be located more quickly than scanning through the records sequentially.

### BRIEF DESCRIPTION OF THE DRAWINGS

FIG. 1 is a block diagram illustrating one embodiment of a database system that uses a skip list within a buffer data structure to process concurrent database transactions.

FIG. 2 is a block diagram illustrating one embodiment of a record chain within the buffer data structure.

FIG. 3 is a block diagram illustrating one embodiment of a skip list within the buffer data structure.

FIG. 4 is a block diagram illustrating one embodiment of a slow skip-list scan.

FIG. 5 is a flow diagrams illustrating one embodiment of a fast skip-list scan.

FIGS. 6A and 6B are block diagrams illustrating embodiments of key space partitionings using key prefixes to facilitate the fast skip-list scan.

FIGS. 7A and 7B are block diagrams illustrating embodiments of anchor record identifications during the fast skip-list scan.

FIG. 8 is a block diagram illustrating one embodiment of climbing the mountain during the fast skip-list scan.

FIGS. 9A and 9B are block diagrams illustrating one embodiment of walking a skip list backwards for record insertion.

FIGS. 10A-10C are flow diagrams illustrating embodiments of methods related to scanning a skip list.

FIG. 11 is a block diagram illustrating one embodiment of an exemplary multi-tenant system.

FIG. 12 is a block diagram illustrating one embodiment of an exemplary computer system for implementing various systems described herein.

### DETAILED DESCRIPTION

In some instances, skip lists may be used to maintain large quantities of information that is frequently manipulated. For example, as will be described below in further detail, a database system may use a buffer data structure to store data of active database transactions until the database transactions can be committed and their data flushed to a persistent storage of the database system. The buffer data structure may include a skip list data structure that enables efficient storage and lookup of transaction records in key order. As this database system may process a high volume of transactions in parallel, efficient scanning of the skip list can be important for database performance.

The present disclosure describes embodiments in which a more efficient scanning algorithm is employed to scan for records in a skip list and/or insert new records in the skip list. As will be described below in various embodiments, a skip list can be divided into sections based on prefixes of the keys such that a given a section includes keys having the same prefix. When a scan for a particular key is performed, the prefix of the key is initially used to determine the relevant section for that prefix. A scan can then be initiated within that section and performed over only a subset of the skip list. This stands in contrast to other approaches in which a scan is initiated at the initial node (i.e., the sentinel node) and performed over the entire skip list. As a given section is considerably smaller than the entire skip list, far fewer memory accesses are performed. This can result in significant performance improvements—particularly in the exemplary database system discussed below, which, in one embodiment, may maintain almost 200,000,000 key-value records in the skip list at a given time.

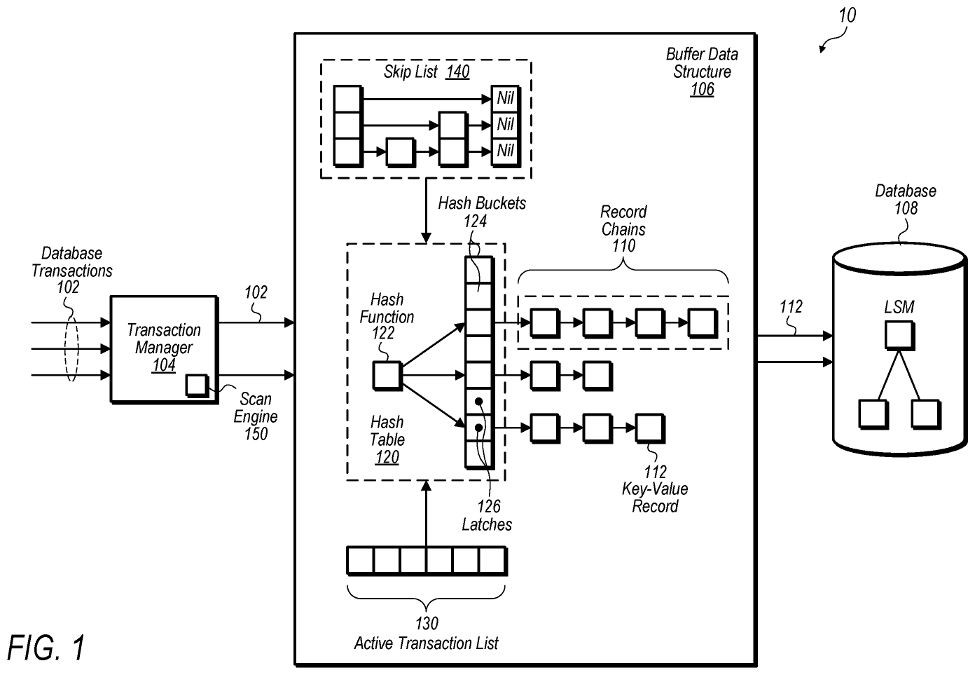

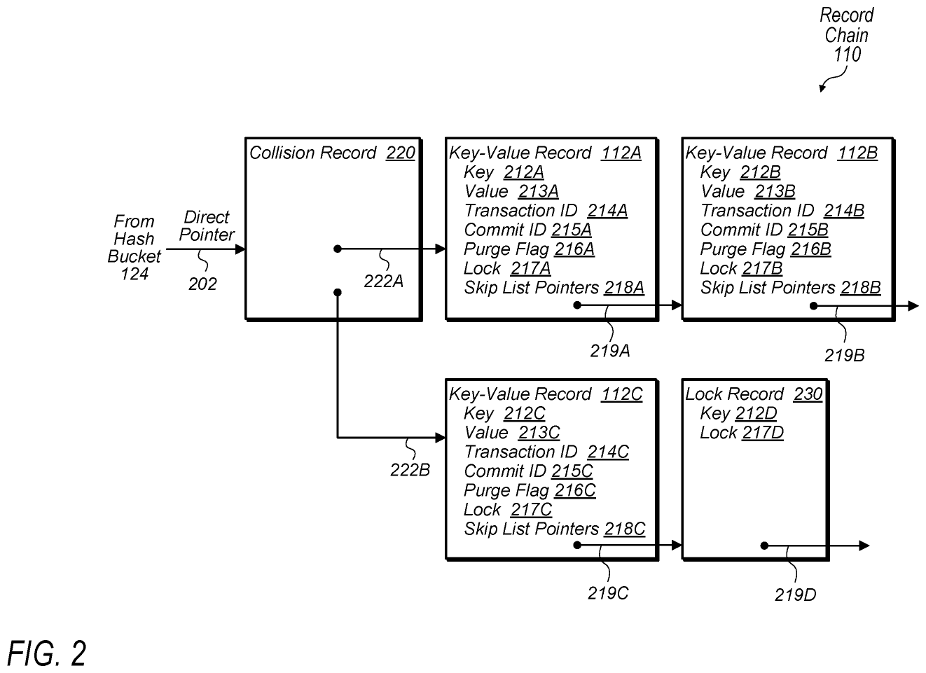

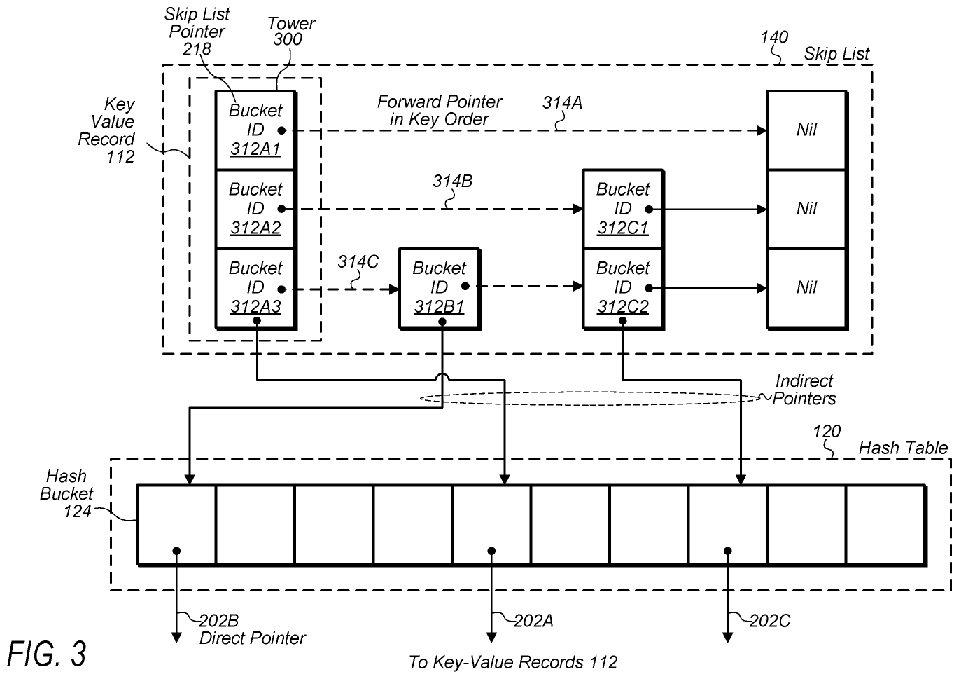

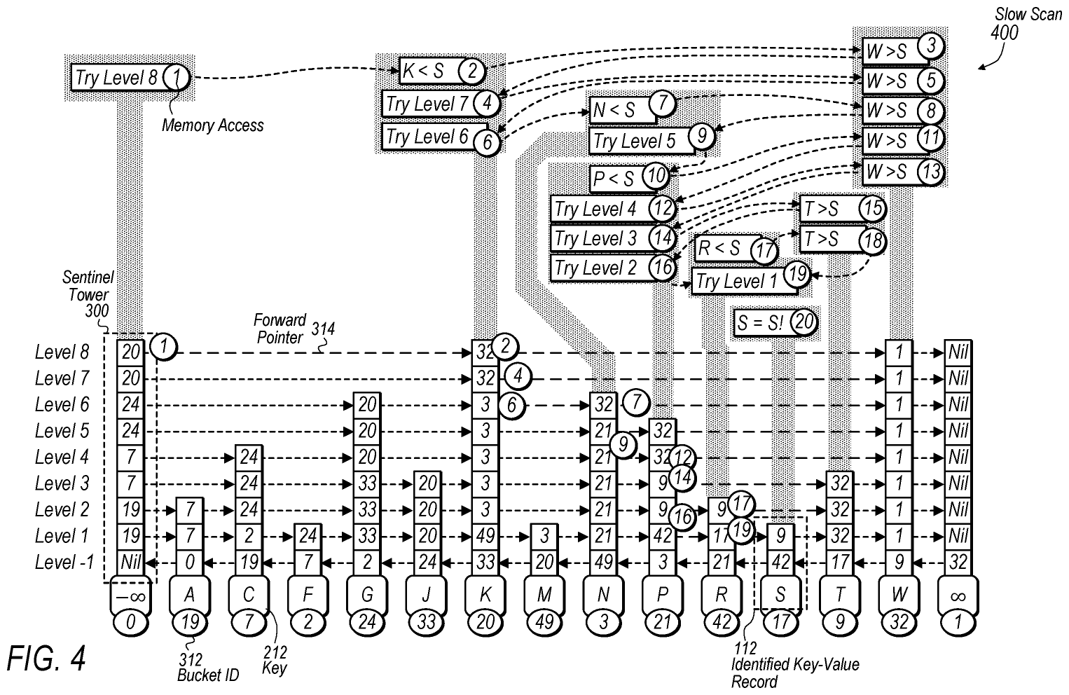

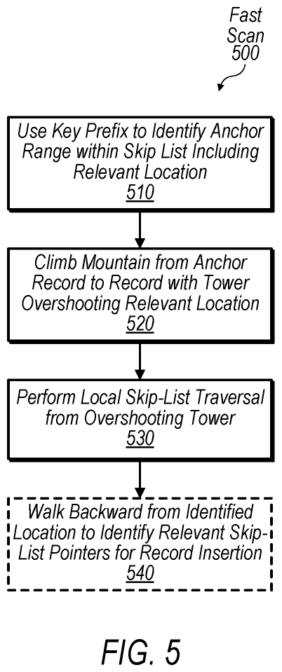

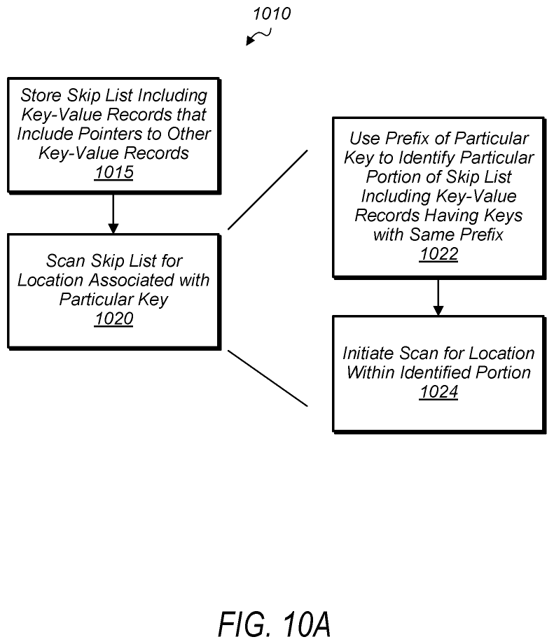

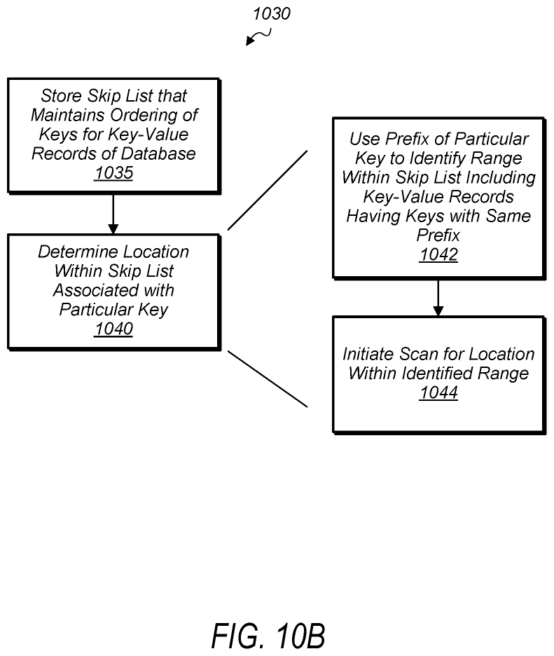

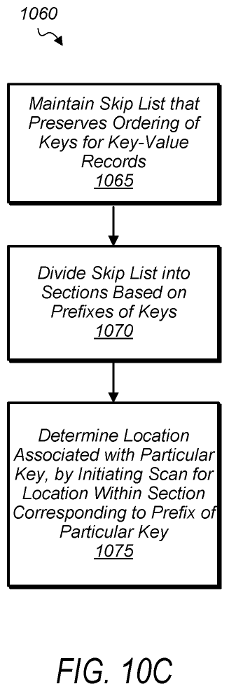

The present disclosure begins with a discussion of a database system in conjunction with FIGS. 1 and 2, which may maintain a skip list and use the fast scan algorithm mentioned above. An exemplary skip list is discussed in conjunction with FIG. 3. A less efficient algorithm for scanning a skip list is then discussed with respect to FIG. 4. A fast scan algorithm is discussed with respect to FIGS. 5-9B. Lastly, methods and exemplary computing systems are discussed with respect to FIGS. 10A-12.

Turning now to FIG. 1, a block diagram of a database system 10 is depicted. In illustrated embodiment, database system 10 includes a transaction manager 104, buffer data structure 106, and a database 108. As shown, buffer data structure 106 includes multiple record chains 110, hash table 120, active transaction list 130, and skip list 140. Record chains 110 include key-value records 112. Hash table 120 includes a hash function 122 and an array of a hash buckets 124, each including a latch 126. (As used herein, the term “latch,” “lock,” and “semaphore” are used generally to refer to a data structure that controls access to a resource shared among multiple potential consumers.) In the illustrated embodiment, manager 104 also includes a scan engine 150. In some embodiments, database system 10 may be implemented differently than shown. For example, in some embodiments, buffer data structure 106 may include more (or less) structures. Although some structures 110, 120, 130, and 140 are depicted separately for illustration purposes, in some embodiments, structures 110, 120, 130, and/or 140 may be intertwined. For example, skip list 140 may be implemented by adding pointers within key-value records 112 in record chains 110.

Transaction manager 104, in one embodiment, includes program instructions that are executable to process received database transactions 102. In general, transactions 102 may be issued to read or write data to database 108 and may be received from any of various sources such as one or more client devices, application servers, software executing on database system 10, etc. As will be described in greater detail below, this processing may entail manager 104 initially storing records 112 for key-value pairs of transactions 102 in buffer data structure 106 until the records 112 can be flushed to the persistent storage of database 108. Accordingly, various functionality described below with respect to buffer data structure 106 may be implemented by transaction manager 104 such as adding key-value records 112 to record chains 110, facilitating acquisition of hash-bucket latches 126 for transactions 102, modifications to active transaction list 130 and skip list 140, etc.

Buffer data structure 106, in one embodiment, is a data structure that buffers key-value pairs for active transactions until the transactions commit. As will be described below, buffer data structure 106 is structured in a manner that allows for quick insertion of key-value pairs, which can be performed concurrently in some instances allowing for high volumes of transactions to be processed efficiently. Still further, buffer data structure 106 may reside in a local memory allowing for faster reads and writes than the persistent storage of database 108 where the data resides long term. In various embodiments, buffer data structure 106 allows concurrent modifications to be performed to it for different transactions 102, but provides a concurrency control mechanism via hash-bucket latches 126 for data within buffer data structure 106. In some embodiments, committed transaction data is asynchronously flushed from buffer data structure 106 to the persistent storage of database 108. That is, rather than perform a flush for each transaction 102's data upon its commitment, a flush is performed periodically for multiple committed transactions 102. For example, in one embodiment, transaction manager 104 initiates a flush to database 108 in response to buffer data structure 106 satisfying a particular size threshold.

Database 108 may correspond to any suitable form of database implementation. In some embodiments, database 108 is a non-relational database that is implemented using a log-structured merge (LSM) tree for persistent storage. In some embodiments, layers of the LSM tree may be distributed across multiple physical computer systems providing persistent storage. In some embodiments, these computers systems are cluster nodes of a computer cluster that provides a cloud-based system accessible to multiple clients. In some embodiments, database 108 may be part of a software as a service (SaaS) model; in other embodiments, database 108 may be directly operated by a user.

As noted above, when transaction manager 104 stores a key-value pair for an active transaction 102 in buffer data structure 106, a corresponding key-value record 112 may be created that includes the value and the key. If multiple transactions 102 attempt to write values associated with the same key, key-value records 112 may be generated for each value and linked to together to form a record chain 110 corresponding to the key. For example, if a user has withdrawn a first amount from a bank account resulting in a first database transaction 102 and then a second amount resulting in a second database transaction 102, a record chain 110 corresponding to an account-balance key may have two key-value records 112 reflecting those withdrawals. In various embodiments, each record 112 includes a transaction identifier (e.g., a transaction sequence number) specifying its associated transaction 102; records 112 may also be organized in a record chain 110 based on the ordering in which the transactions 102 are received. For example, as described below with respect to FIG. 2, record chains 110 may be implemented using linked lists such that a new record 112 is inserted at the head of the linked list and migrates to the tail as newer records 112 are created and older ones are flushed to database 108. To facilitate quick access to key-value records 112, record chains 110 are appended to hash buckets 124 of hash table 120.

Hash table 120, in one embodiment, is a data structure that allows constant-time lookups of record chains 110 based on given a key. That is, when a key is received, hash table 120 is indexed into by applying hash function 122 to the key to produce the appropriate index value for the hash bucket 124 corresponding to the key. The direct pointer in the hash bucket 124 may then be referenced to obtain to the record chain 110. Being able to perform constant-time lookups may significantly reduce the time consumed to read key-value records 112, write records 112, or perform key probes (i.e., determining whether a key has a key-value record 112 present in buffer data structure 106).

As noted above, in various embodiments, each hash bucket 124 includes a respective latch 126 that controls access to its record chain 110. Accordingly, when a transaction is attempting to read or write a value associated with a particular key, the key may be used to index into hash table 120 and acquire the latch 126 corresponding to the key's associated hash bucket 124 before reading or writing is performed. If a latch 126 cannot be acquired for a database transaction 102, processing the database transaction 102 may be delayed until the latch 126 is released. In some embodiments, latches 126 may have one of three possible states: available, shared acquired, and exclusively acquired. If no transaction 102 is currently accessing a record chain 110, its latch 126 is available for acquiring. If a transaction 102 is performing a read of a key-value record 112, the latch 126 may be acquired in a shared state—meaning that other transactions 102 can also acquire the latch 126 as long as they are also performing a read (i.e., not attempting to modify a record 112 while it is also being read). If a transaction 102 is performing a write, however, the latch 126 is acquired for the transaction 102 in an exclusive state—meaning no other transaction 102 may acquire the latch 126 until it is released. Accordingly, if two transactions 102 are attempting to perform writes for the same key, the later transaction is delayed until the former completes its write operation and releases the latch 126. If a transaction 102 is attempting to access multiple key-value pairs, latches 126 may be acquired in ascending order of buckets 124 to prevent deadlock. Although acquisition of latches 126 may be discussed primarily with respect to read and write operations, latches 126 may also be acquired when performing other operations such as defragmentation, garbage collection, flushing records 112 to the persistent store of database 108, etc. In some embodiments, latches 126 may also serve as a concurrency control mechanism for active transaction list 130 and skip list 140.

Active transaction list 130, in one embodiment, is a data structure that tracks various metadata for active transactions 102. In various embodiments, the metadata for a given transaction 102 includes a transaction identifier for the transaction 102 and one or more pointers usable to access records 112 associated with the transaction 102. In doing so, list 130 enables a transaction 102's records 112 to be identified based on its transaction identifier, which may be helpful when, for example, determining which records 112 should be removed if the transaction 102 is being rolled back. The metadata may also include an indication of whether a transaction is active or committed, which may be used to determine if its records 112 can be marked for flushing to database 108.

Skip list 140, in one embodiment, is a data structure that maintains an ordering of keys in records 112 to allow forward and reverse scanning of keys. In some embodiments, database 108 may be configured such that records 112 for committed transactions 102 are flushed in ascending key order (as well as version order); skip list 140 may allow this ordering to be quickly and easily determined. As will be described in greater detail below with respect to FIG. 3, in some embodiments, skip list 140 includes indirect pointers for accessing records 112 of skip list 140. That is, rather than have direct pointers between records 112 (i.e., pointers specifying the memory addresses of records 112), skip list 140 includes indirect pointers to the hash buckets 124, which include the direct pointers to chains 110. Advantageously, if a new record 112 gets added to a record chain 110, the direct pointer in the hash bucket 124 is updated, not the indirect pointer in skip list 140. Use of indirect pointers may also enable skip list 140 to leverage hash-bucket latches 126 when manipulating records 112 with respect to list 140. Accordingly, if a record 112 for a transaction 102 is being accessed through skip list 140 for modification or removal, a latch 126 may be acquired for the record 112's key to prevent other modifications from being performed. As noted above, although shown separately from records 112 in FIG. 1, portions of skip list 140, in some embodiments, may reside in records 112 as will be discussed with respect to FIGS. 2 and 3.

As records 112 are inserted into buffer data structure 106, a scan of skip list 140 may be performed to determine where to insert the records in skip list 140. Once records 112 have been inserted, additional skip list scans may be performed to locate particular records 112 in skip list 140. In the illustrated embodiment, scan engine 150 is a component of transaction manager 104 that is executable to scan skip list 140 and may implement the fast scan algorithm discussed in more detail below starting with FIG. 5. Accordingly, as noted above, scan engine 150 may divide skip list 140 into sections (referred to below as “anchor ranges”) based on prefixes of the keys such that a given a section includes keys having the same prefix. To facilitate looking up particular sections, in various embodiments, scan engine 150 maintains an index that can be referenced to determine the relevant section for a given key prefix so that a scan can then be initiated within that section. As will be discussed below, in some embodiments, this index is integrated into hash table 120 by adding pointers in hash buckets 124 to records 112 in respective sections (referred to as “anchor records”) so that a given section can be located quickly for a given key prefix. Once a relevant section is determined for a given key prefix, scan engine 150 may sequentially scan through records implementing a technique referred to below as “climbing the mountain.” In various embodiments, scan engine 150 may also be responsible for maintaining skip list 140 including performing record insertion (and record removal) for skip list 140. As will be discussed, once a location for a record insertion has been determined from the scanning, scan engine 150 may “walk backwards” from the location to determine what pointers in other records 112 should be updated when the record 112 is inserted as well as determine the pointers to include in the skip list tower of the record 112. In some embodiments, scan engine 150 manages a thread pool of executing threads in order to implement parallel fast scans.

The contents of records 112, including those used to implement skip list 140, will now be discussed in greater detail in order to facilitate better understanding of the fast scan algorithm discussed in detail later.

Turning now to FIG. 2, a block diagram of a record chain 110 is depicted. As shown, record chain 110 may include a collection of key-value records 112A-112C, a collision record 220, and a lock record 230. Records 112 may further include a key 212, value 213, transaction identifier 214, commit identifier 215, purge flag 216, lock 217, skip list pointers 218, and record-chain pointer 219. In some embodiments, chain 110 may include more (or fewer) records 112, 220, or 230 than shown; a given record 112 may also include more (or fewer) elements 212-219 than shown.

In the illustrated embodiment, record chain 110 is implemented using a linked list such that each key-value record 112 includes a pointer 219 identifying the next record 112 in the chain 110. When a record 112 is added, it is inserted at the head identified by the direct pointer 202 in the hash bucket 124 or appended to a collision record 220 discussed below. The added record 112 may then include a pointer 219 to the record that was previously at the head. As the record 112 becomes older, it migrates toward the tail (record 112B or lock record 230 in FIG. 2) until its transaction 102 commits. Then, it may be flushed to database 108's persistent storage and removed. A given record 112's transaction identifier 214 may identify, not only the transaction 102 to which the record 112 is associated, but also indicate the ordering in which transactions 102 were received. Accordingly, since record 112B is further from the head than record 112A, transaction ID 214B may correspond to an earlier transaction 102 than transaction ID 214A. If the transaction 102 corresponding to transaction ID 214B is to be rolled back, transaction manager 104 may locate record 112B by referencing direct pointer 202 to identify the head of chain 110 and traverse through records 112A and 220 until finding the record 112B having the corresponding transaction ID 214B. Record 112B may then be removed and pointer 222A modified to have the same address as pointer 219B. In some embodiments, if a transaction 102 commits, the commit identifiers 215 for its records 112 may be set to reflect the commitment and mark the record 112 as being ready for flushing to database 108's persistent storage. Records 112 may later be scanned by a process of transaction manager 104 to identify which records 112 have commit identifiers 215 and to determine which records 112 can be flushed to database 108.

Once a key-value record 112 has been successfully flushed to persistent storage, in some embodiments, transaction manager 104 sets a purge flag 216 to indicate that the record 112 is ready for purging from buffer data structure 106. In some embodiments, a purge engine may then read this flag 216 in order determine whether the record 112 should be purged from buffer data structure 106.

In some embodiments, collision records 220 are used to append records 112 to chain 110 when two different keys (e.g., keys 212A and 213C) produce the same hash value (i.e., a hash collision occurs) and thus share the same hash bucket 124. In various embodiments, the size of hash table 120 is selected to have a sufficient number of hash buckets 124 in order to ensure a low likelihood of collision. If a hash collision occurs, however, a record 220 may be inserted including pointers 222 to records 112 having different keys 212. Although, in many instances, a hash-bucket latch 126 is specific to a single respective key 212, in such an event, the hash-bucket latch 126 would be associated with multiple, different keys 212.

As noted above, in some embodiments, individual records 112 may also include their own respective locks 217 to provide additional coherency control. In some embodiments, a separate lock record 230 may also be inserted into record chains 110 to create a lock tied to a particular key when there is no corresponding value.

Skip list pointers 218, in one embodiment, are the pointers that form skip list 140. As will be discussed next with FIG. 3, pointers 218 within a given record 112 may form a pointer tower that implements a linked hierarchy of data records sequences, with each successive sequence skipping over fewer records 112 than the previous sequence. In some embodiments, pointers 218 are also implemented using indirect pointers through which key-value records 112 are linked together in skip list 140 without using direct pointers to the physical addresses of records 112. Instead, pointers 218 reference the hash buckets 124 that point to the record chains 110 including records 112. In various embodiments, using indirect pointers greatly simplifies pointer management because only one direct pointer may be maintained for a given record 112. That is, since the location of the hash bucket 124 remains in the same, the indirect pointer is not updated if a record 112 is moved, for example, to a later position in a record chain 110.

Turning now to FIG. 3, a block diagram of skip list 140 is depicted. As noted above, in various embodiments, skip list 140 may be used to maintain an ordering of keys 212 stored in records 112, which may be used to flush records 112 of committed transactions 102 in ascending key order. In the illustrated embodiment, skip list pointers 218 within a record 112 form a tower 300 that point to towers 300 in other records 112.

When a particular key 212 is being searched in skip list 140, traversal of skip list 140 may begin, in the illustrated embodiment, at the top of the left most tower 300 (the location corresponding to bucket ID 312A1 in the illustrated embodiment), where the key 212 in record 112 is compared against the key being searched. If there is a match, the record 112 being searched for has been located. If not, traversal proceeds along the path of forward pointer 314A to another record 112 having another key 212, which is compared. If that key 212 is less than key 212 being searched for, traversal returns to the previous tower 300 and drops down to the next level in the tower 300 (the location of bucket ID 312A2 in FIG. 3). If, however, the key 212 being search for is greater than the other key 212, traversal proceeds forward along another pointer 314. This process then continues onward until a match is identified for the record 112 being searched for. An example of this traversal will be discussed below with FIG. 4.

Although forward pointers 314 are depicted in FIG. 3 (and subsequent figures) to facilitate understanding, skip list pointers 218, in some embodiments, are implemented using indirect pointers. In the illustrated embodiment, skip list pointers 218 are specifically implemented using bucket identifiers 312 that point to buckets 124 in hash table 120, which in turn point to records 112 via pointers 202. Thus, proceeding along pointer 314C includes following the pointer 218 of bucket ID 312A3 to a bucket 124 and proceeding along pointer 202A to the record chain 110 including the record 112 with the pointer 218 of bucket 312B1. Although not depicted, in some embodiments, skip list 140 also includes a set of backward pointers, which may be implemented in a similar manner and will be discussed in greater detail below.

Before discussing the fast scan algorithm, it is instructive to consider how a less efficient scan algorithm is implemented.

Turning now to FIG. 4, a block diagram of a slow scan 400 is depicted. As will be discussed, slow scan 400 is a less efficient algorithm than the fast scan algorithm described herein as it can use a far greater number of memory accesses to scan for a particular key 212. As shown in FIG. 4, an example skip list 140 may be constructed from records 112 sorted in ordering of keys 212 A-W. The skip list 140 includes eight levels (shown as levels 1-8) of forward pointers 314 allowing for movement in ascending key order and another level (shown as level −1) of backward pointers allowing for movement in descending key order. Sentinel towers 300 are located at either end of the skip list 140 and do not correspond to a record 112 (and thus are shown having keys of −∞ and ∞). Also, beneath each key 212 in FIG. 4 is the bucket identifier 312 for the bucket 124 including a direct pointer 202 to that record 112 (or its record chain 110). Thus, as shown, the bucket 124 having the bucket identifier 312 of 19 includes a pointer 202 to a record 112 with a key 212 of A.

In the example depicted in FIG. 4, slow scan 400 is being performed to locate a record 112 having key 212 of S (or simply “record S”). As shown, scan 400 begins with skip-list traversal at the top of the sentinel tower 300 on the left in which a first memory access is performed to read the skip list pointer 218 at level 8, which includes a bucket ID 312 of 20. A second memory access is then performed to read the record 112 pointed to by bucket #20, which is a record 112 having a key K. Because the key S is greater than key K in key order, the traversal continues along level 8 where a record W is read during a third memory access. Because key S is less than key W, the traversal returns to record K in a fourth memory access to read the skip list pointer 218 for the level 7, the next level down.

As can be seen, this process continues for another twenty memory accesses until record R is identified as having a pointer 218 of bucket #17 to record—not including the additional memory accesses for using indirect pointers or the multiple accesses to move down a record chain 110. Furthermore, slow scan 400 may be performed multiple times to insert multiple records 112 associated with a given transaction. Moreover, in some embodiments, skip list 140 may include much taller skip list towers 300 (e.g., ones having 33 levels) and be substantially wider. All these memory accesses can affect system performance. In many instances, the fast scan algorithm discussed next uses far fewer memory accesses.

Turning now to FIG. 5, a flow diagram of a fast scan 500 is depicted. As noted above, fast scan 500 may be an algorithm used by scan engine 150 to more quickly scan skip list 140 in response to receiving a request to identify a relevant location for a given key. Although depicted as including steps 510-540, fast scan 500 may include more (or fewer steps) than shown. For example, step 540 may not be included if scan 500 is being performed for something other than record insertion.

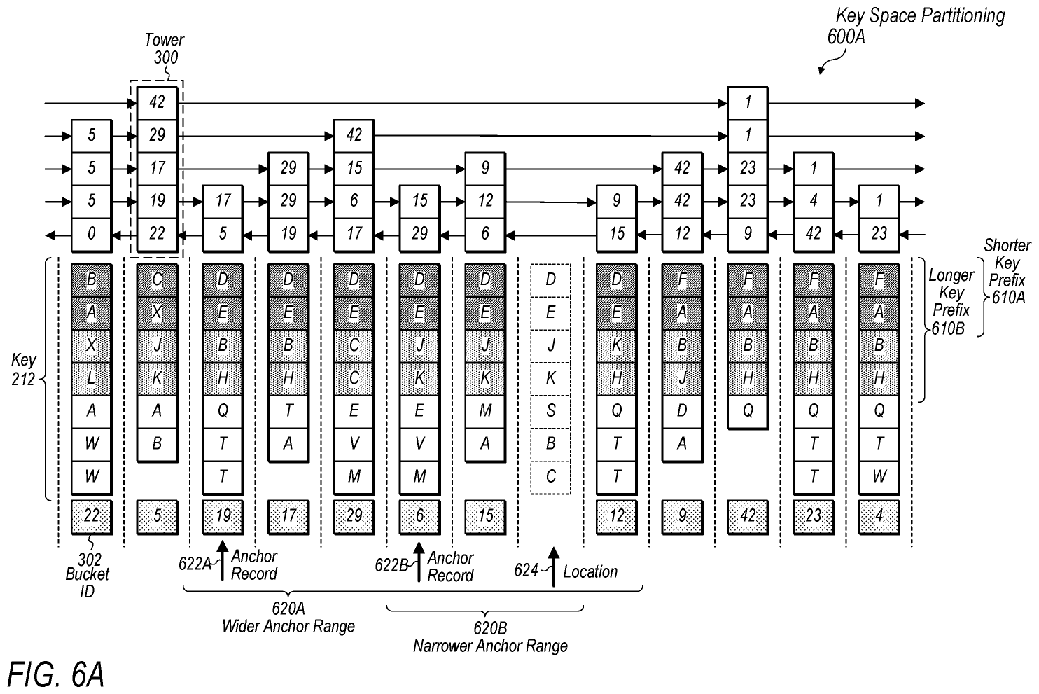

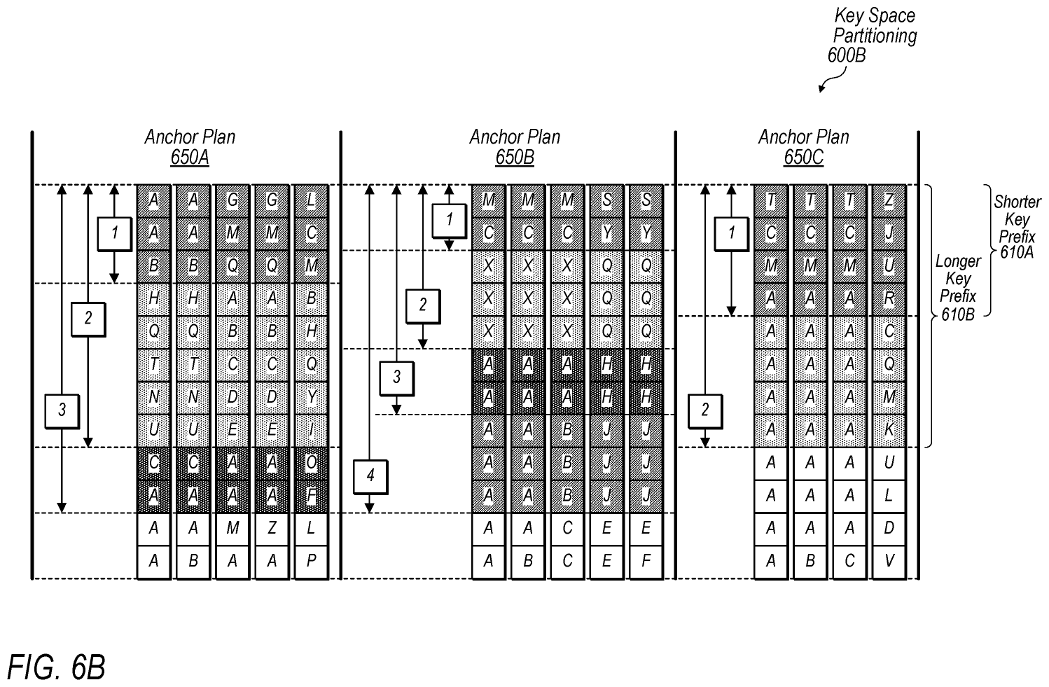

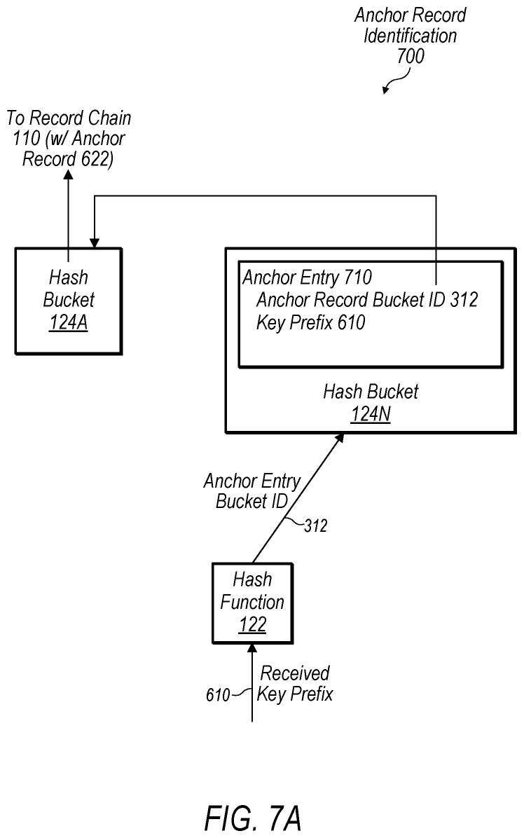

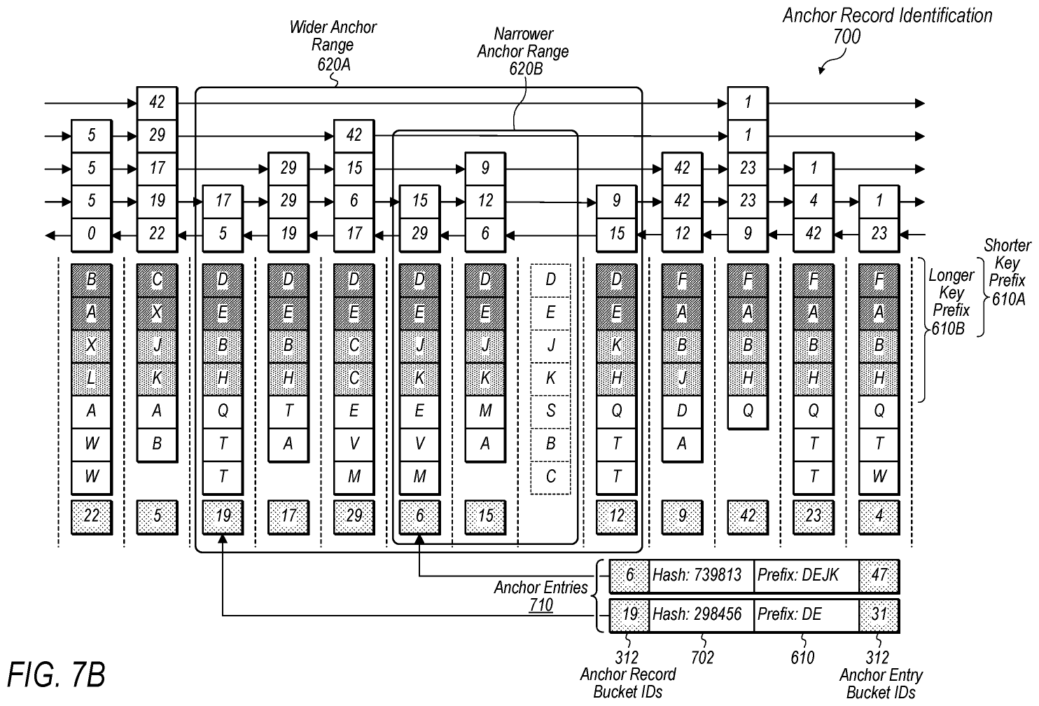

In the illustrated embodiment, fast scan 500 begins in step 510 with scan engine 150 using a prefix of a particular key to identify an anchor range within skip list 140 including the relevant location for the particular key. As noted above, an “anchor range” is a set/range of records in a skip list that have the same key prefix and is used to anchor where a skip list scan is initiated. As will be discussed below with FIGS. 6A and 6B, scan engine 150 may use key prefixes of varying lengths in order to produce anchor ranges having varying widths so that a scan can be initiated from the narrowest anchor range available. As will be discussed below with FIGS. 7A and 7B, scan engine 150 may identify the anchor range for a particular key prefix using an index that associates key prefixes to anchor ranges by including respective pointers to “anchor records” in those ranges. In some embodiments, the anchor record for a particular anchor range is the record 112 having the lowest key 212 for that anchor range while still having the same prefix. Once an anchor record 112 has been located, scan engine 150 can initiate a scan from the anchor record 112 using it as a starting point to find the relevant location.

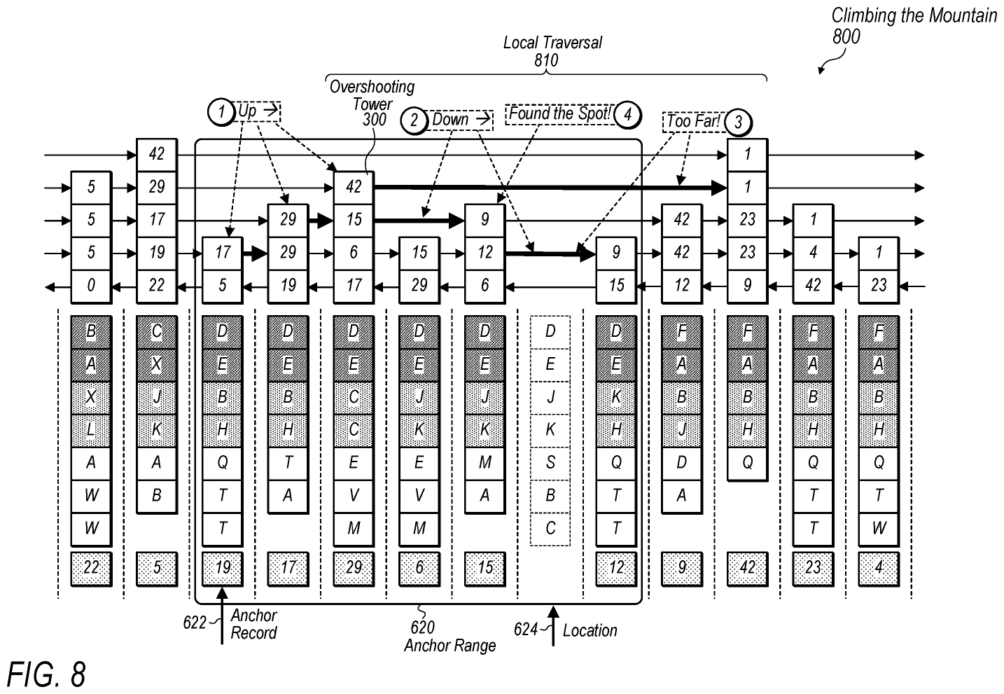

In step 520, this scan begins with scan engine 150 “climbing the mountain” from an anchor record to a record 112 having a skip list tower 300 that overshoots the relevant location. As will be discussed below with FIG. 8, the anchor record may not include a tower with sufficient height to allow the relevant location to be determined using only a skip-list traversal. Thus, scan engine 150 may scan forward from the anchor record using the highest available tower pointers until a key-value record 112 is identified that includes a skip list tower 300 with a pointer 314 that overshoots the location (i.e., the key-value record 112 pointed to by the pointer 314 has a later key in key order than the particular key). In some instances, the relevant location may be identified as part of this forward scan without performing step 530.

In step 530, once an overshooting tower 300 has been identified, scan engine 150 performs a local skip list traversal from the overshooting tower 300 to identify the relevant location for the particular key. In various embodiments, this local skip list traversal may be implemented in a manner similar to slow scan 400, but without starting at a sentinel tower. If scan 500 is being performed to access a record 112, scan 500 may conclude with scan engine 150 accessing the contents of the record 112 once the traversal identifies its location. If a record 112 is being inserted at the location, scan 500 may proceed to step 540 to determine how skip list 140 should be modified to facilitate the insertion.

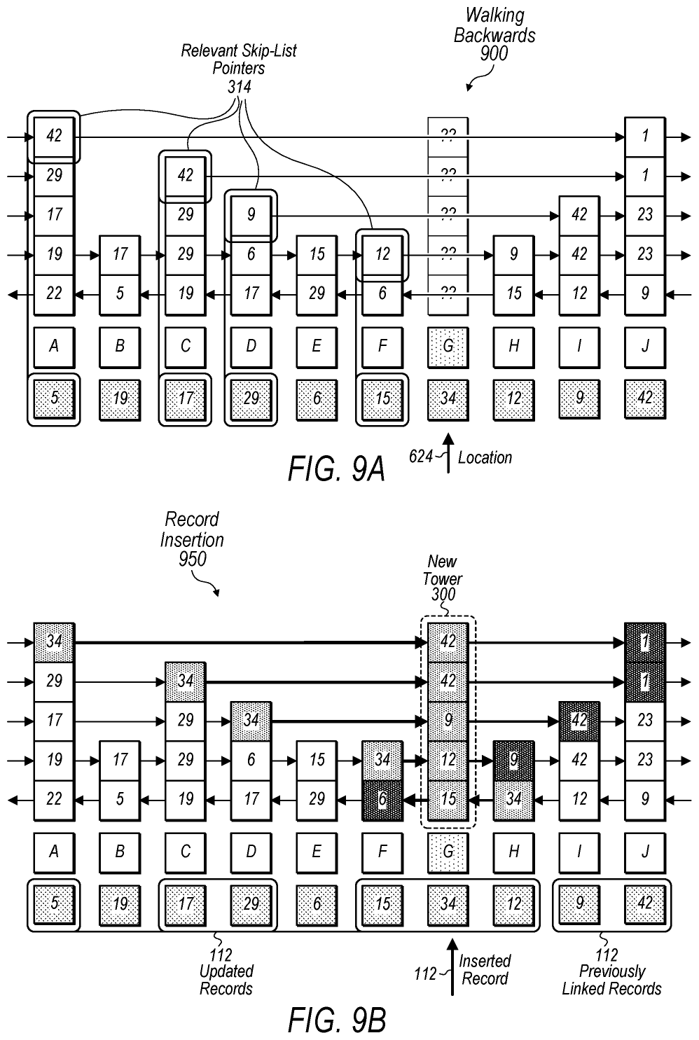

In step 540, scan engine 150 walks backwards from the identified location in the skip list 140 to identify skip-list pointers 314 relevant to the record insertion. As will be discussed with FIGS. 9A and 9B, scan engine 150 scans sequentially backwards until it has identified an overshooting pointer for each level in the tower 300 of the record 112 being inserted. Once all of these relevant pointers 314 have been identified, scan engine 150 may then insert the new record 112 at the determined location and include, in the new record 112, the tower 300 with the identified pointers 314. Scan engine 150 then updates the relevant pointers 314 in the other towers 300 to point to the newly inserted record 112.

In many instances, fast scan 500 results in far fewer memory accesses than slow scan 400 as a skip list traversal is only performed on a small subset of the total records 112 in skip list 140. Although some additional memory accesses may be performed to facilitate this local skip list traversal, employing techniques such as climbing the mountain and walking backwards for relevant pointer identification ensures that the number of additional memory access, in many instances, falls well below those needed to perform a slow scan 400.

Various examples of dividing skip list 140's key space using key prefixes will now be discussed.

Turning now to FIG. 6A, a block diagram of key space partitioning 600A is depicted. As shown and previous discussed, skip list 140 includes a set of records 112 having respective keys 212 and accessible from buckets 124 having various bucket identifiers 302. Records 112 are also arranged in key order and have respective skip list towers 300. In the illustrated embodiment, key space partitioning 600A uses two different key prefixes 610 to divide the key space: a shorter key prefix 610A and a longer key prefix 610B. As can be see, shorter key prefix 610A results in a wider anchor range 620A with a greater number of records 112. In the depicted example, range 620A has an anchor record 622A in bucket 19 as key 212 “DEBHQTT” is the lowest key for “DE” key prefix 610A. Longer key prefix 610B results in a narrower anchor range 620B having fewer records 112 and having an anchor record 622B as key 212 “DEJKEVM” is the lowest key for the “DEJK” key prefix 610B. Although anchor ranges 620A and 620B are shown as having separate anchor records 622A and 622B, it is worth noting that an anchor record 622 can participate in multiple anchor ranges 620 based on different length prefixes 610 of the record 112's key 212. For example, anchor record 622A is also the anchor record for the longer “DEBH” key prefix 610.

In the example depicted in FIG. 6A, scan engine 150 is performing a scan for a location 624 corresponding to the key 212 “DEJKSBC” for a record 112 being inserted into skip list 140. In various embodiments, scan engine 150 initially selects the longest available prefix 610 of the particular key 212 to determine whether a relevant anchor range 620 of skip list 140 exists as this can result in fewer records 112 being scanned. In the depicted example, the longer key prefix 610B of “DEJK” does have a corresponding anchor range 620B, so scan engine 150 can initiate a scan from anchor record 622B. If, however, the longer key prefix 610B was “DEJA,” no corresponding anchor range 620 exists in this example as no other records 112 have this prefix. In various embodiments, in response to determining that a relevant anchor range 620 does not exist in skip list 140 for the longest prefix 610, scan engine 150 selects the next longest prefix 610 of the particular key 212. In this example, scan engine 150 is able to fall back and use shorter key prefix 610A as “DE” is still a component of the key 212. Although a scan from anchor record 622A through wider anchor range 620A results in more records 112 being scanned than narrower anchor range 620B, the number of scanned records is still far fewer than those scanned when performing slow scan 400 in many instances. If no corresponding anchor range exists (e.g., the key has a prefix 610 of “DFAC”), scan engine 150 can fall back further and use slow scan 400 to identify location 624. Once this record 112 is inserted, however, it can become the anchor record 622 for both the DF prefix 610 and the DFAC prefix 610 enabling faster scans for those prefixes 610 in the future.

Although partitioning 600A uses the same key prefix lengths across the entire key space, in some embodiments, different key prefix lengths may be used for different portions of the key space as will be discussed next.

Turning now to FIG. 6B, a block diagram of another key space partitioning 600B of is depicted. In the illustrated embodiment, different portions of the key space may use differing anchor plans 650 for dividing up the key space using differing numbers of prefixes 610. For example, as shown, an anchor plan 650A using three different prefixes 610 is used for keys 212 having an initial letter of A-L, an anchor plan 650B using four different prefixes 610 is used for keys 212 having an initial letter of M-S, and an anchor plan 650C using two different prefixes 610 is used for keys 212 having an initial letter of T-Z. In such an embodiment, scan engine 150 may initially access anchor plans 650 to determine which lengths of prefixes should be used for a given key 212. For example, if a scan is being performed for a key 212 having an initial letter G, scan engine 150 may determine from anchor plan 650A that an initial prefix 610 of ten characters should be used, followed by a prefix 610 of eight characters, and then a prefix of three characters.

In various embodiments, differing anchor plans 650 may be selected based on the underlying distribution of keys 212 in skip list 140. For example, a portion of a key space having a greater concentration of keys 212 may use additional prefixes 610. In some embodiments in which database system 10 implements a multi-tenant database, scan engine 150 may use different anchor plans 650 for different tenants. Still further, prefixes 610 may be selected to group records 112 having a common attribute (e.g., being included in the same database table) into the same anchor range 620. In some embodiments, scan engine 150 may also alter anchor plans 650 over time in order to improve performance. For example, in one embodiment, scan engine 150 may use a machine learning algorithm to determine appropriate anchor plans 650 for various divisions of the key space. Such alterations, however, may not be devastating for database system 10 as scan engine 150 can initially fall back to using slow scan 400 for inserting records 112 until a sufficient number of records 112 have been inserted under a new anchor plan 650 making fast scan 500 viable again. As the temporary performance loss for changing anchor plans likely affects only a small number of scans, such alterations may not be a big problem.

Turning now to FIG. 7A, a block diagram of an anchor record identification 700 is depicted. As noted above, in various embodiments, scan engine 150 maintains an index that associates key prefixes 610 to key-value records 112 in respective anchor ranges 620 having the same key prefixes and accesses the index to identify a relevant anchor record 622 from where to initiate a scan. In the illustrated embodiment, this index is implemented by including anchor entries 710 in hash buckets 124. Each anchor entry 710 further includes a bucket identifier 312 for an anchor record 622 and its corresponding key prefix 610. In other embodiments, the index may be implemented differently. For example, anchor entries 710 may be located elsewhere such as being appended in record chains 110, anchor entries 710 may include more (or fewer) components, a key prefix 610 may be replaced with a hash value generated from the key prefix 610 (such as depicted in FIG. 7B), the index may be implemented using a data structure other than hash table 120, etc.

In the illustrated embodiment, scan engine 150 implements anchor record identification 700 by applying hash function 122 to a given prefix 610 to determine the bucket identifier 312 for the relevant hash bucket 124 (e.g., bucket 124N). If a corresponding anchor entry 710 exists in the bucket 124 (meaning that a corresponding anchor range 620 exists for that prefix 610), the included bucket identifier 312 for the anchor record 622 is read to determine the hash bucket 124 relevant to the anchor record 622. This bucket identifier 312 is then used to access anchor records 612's hash bucket 124 (e.g., bucket 124A). Scan engine 150 then traverses the pointer in the bucket 124 to the anchor chain 110 including the anchor record 622. If, however, no anchor entry 710 existed in the hash bucket 124 (meaning that a corresponding anchor range 620 does not yet exist), scan engine 150 may proceed to use the next largest key prefix 610 for the particular key 212 and continually repeat this process until a relevant anchor record 622 can be identified—or proceed to perform a slow scan 400 if no anchor entry 710 can be identified for any key prefix 610 of the key 212.

In various embodiments, scan engine 150 creates an anchor entry 710 for an anchor range 620 when an initial record 112 gets added to the range 620—the initial record 112 becoming the anchor record 622. As records 112 with lower keys 212 get added to the range 620 (or records 112 with lower keys 212 get purged), scan engine 150 updates anchor record bucket identifier 312 in the anchor entry 710 to point to hash buckets 124 of these new anchor records 622 (or the records 112 with the next lowest keys 212). If each record 112 for a particular anchor range 620 is purged, scan engine 150 may remove the corresponding anchor entry 710 from its hash bucket 124. In some instances, multiple anchor entries 710 may be modified for a given key 212 if its corresponding record 112 becomes the anchor record 622 for multiple prefixes 610.

In some rare instances, two prefixes 610 may map to the same hash bucket 124 due to a hash collision. Thus, scan engine 150 may compare the prefix 610 being hashed to the key prefix 610 in an anchor entry 710 in order to confirm that the anchor entry 710 is the correct one for the prefix 610 being hashed. In some embodiments, a given hash bucket 124 may include multiple anchor entries 710 if two prefixes 610 are associated with the same hash bucket 124. In another embodiment, an anchor entry 710 for a colliding prefix 610 may be stored in a collision record 220 pointed to by the hash bucket 124. In other embodiments, other techniques may be used to handle collisions such as preceding to use the next longest prefix 610 for a particular key 212 being scanned.

Turning now to FIG. 7B, a block diagram illustrating an example of anchor record identification 700 is depicted. Continuing with the example introduced with FIG. 6A, scan engine 150 is again attempting to determine a relevant location 624 for the key 212 ““DEJKSBC.”In this example, scan engine 150 may initially apply hash function 122 to longer prefix 610B “DEJK” to obtain a bucket identifier 312 “31.” There, scan engine 150 may compare a hash value of “DEJK” with a hash value 702 “739813” in order to determine that the anchor entry 710 is the correct one. If so, scan engine 150 may read the bucket identifier 312 “6” and then access the corresponding bucket 124, where scan engine 150 is able to access the anchor record 622 for narrower range 620 and initiate a scan. If, however, no corresponding entry 720 existed (or the hash value 702 did not match), scan engine 150 may apply hash function 122 to the shorter prefix 610A “DE” and access the corresponding entry 710 to determine the anchor record 622 for wider anchor range 620A where a scan can be initiated as will be discussed next.

Turning now to FIG. 8, a block diagram of “climbing the mountain” 800 is depicted. Once scan engine 150 has determined the anchor record 622 for a given prefix 610, scan engine 150 may read the tower 300 in that record 121 to determine one or more pointers 314 for scanning forward in the anchor range 620 for a relevant location 624. In many instances, however, the tower 300 is not sufficiently tall enough to perform a skip list traversal (i.e., it does not have a pointer 314 pointing to a record 112 located after location 624). Although scan engine 150 could scan sequentially forward through records 112, this approach is inefficient and does not leverage the logarithmic scanning afforded by skip lists. Thus, in the illustrated embodiment, scan engine 150 uses climbing the mountain 800.

In various embodiments, this technique begins with scan engine 150 “climbing up the mountain”—meaning that the scan engine 150 scans forward from the anchor record 622 along the highest available pointers 314 in skip list 140's towers 300 until an overshooting tower 300 (i.e., tower 300 with a pointer 314 that points past/overshoots the location 624) can be identified. Accordingly, in the example depicted in FIG. 8, scan engine 150 may traverse the pointer 314 “17” in the anchor record 622, the pointer 314 “29” in the next record 112, and the pointer 314 “42” in the following record 112 as these are the highest available pointers in towers 300 of these records 112. An advantage of climbing up the mountain is that any intermediary records 112 with shorter towers 300 can be skipped over—resulting in a logarithmic scanning on the upward climb. In some instances, location 624 may be among the records 112 being accessed on this upward climb.

Once an overshooting tower 300 has been identified, scan engine 150 may “climb down the mountain” using a local skip-list traversal 810. In various embodiments, local traversal 810 is implemented in the same manner as the skip-list traversal in slow scan 400; however, traversal 810 is a “local” performance—meaning that is initiated from the overshooting tower 300, not the sentinel tower 300. Accordingly, in response to determining that pointer 314 “42” points past location 624 in the depicted example, scan engine 150 may traverse the next highest pointer 314 “15,” traverse pointer 314 “9,” and then, after overshooting, determine location 624. As a local traversal 810 also affords logarithmic scanning, the process of climbing up and climbing down the mountain is an efficient approach for determining a relevant location 624 once a relevant anchor range 620 has been identified.

If scan 500 is being performed to locate an existing record 112, scan 500 may conclude with scan engine 150 providing the record 112's contents. If, however, scan 500 is being performed to insert a record 112, scan engine 150 may need to perform additional work to determine what pointers 314 should be included in the record 112 and what pointers 314 should be altered in other records 112 as discussed next.

Turning now to FIG. 9A, a block diagram of “walking backwards” 900 is depicted. In slow scan 400, the relevant pointers 314 for facilitating a record insertion may be determined as the scan 400 is being performed. As scan engine 150 may not access all relevant pointers 314 while performing climbing the mountain 800, scan engine 150 may perform walking backwards 900 to account for this.

In the illustrated embodiment, scan engine 150 implements walking backwards 900 by sequentially scanning backwards along a lowest level in skip list 140 to identify pointers 314 in other records 112 that are relevant to the key-value record 112 being inserted into skip list 140. In various embodiments, scan engine 150 may initially determine the height of the new tower 300 for the record 112 being inserted in order to know how many levels will be in the new tower 300—and thus know the number of relevant pointers 314 for insertion into the tower 300. In some embodiments, scan engine 150 determines the tower 300's height using a power of 2 back off—meaning that skip list tower heights are assigned logarithmically with ½ being one tall (not including the lowest, reverse level), ¼ being two tall, and so on. In one embodiment, scan engine 150 may determine a tower 300's height by generating a random number and counting the number of consecutive 1s (or Os) from the most significant bit (or least significant bit). Once the tower height is determined, scan engine 150 may scan sequentially backwards until engine 150 has identified an overshooting pointer 314 for each level in the new tower 300. Accordingly, in the example depicted FIG. 9A, a tower height of four forward pointers 314 is being used. Thus, scan engine 150 may scan sequentially backwards until it has pointers 314 “12,” “9,” “42,” and “42” at each of the four levels. As relevant pointers 314 are identified, scan engine 150 may pin the records 112 by recording their relevant pointers 314 and the corresponding bucket identifiers 312 of the records 112.

In some instances, scan engine 150 may not perform walking backwards 900 if a record 112 being inserted has a tower 300 that is tall enough (e.g., in some embodiments, exceeding eight levels, which is a rare occurrence) to make walking backwards 900 a less efficient approach than performing a slow scan 400 to determine the set of relevant pointers 314. Accordingly, in some embodiments, prior to scanning sequentially backwards, scan engine 150 may determine a number of pointers 314 being included in the new records 112's tower 300. Based on the determined number, scan engine 150 determining whether to traverse skip list 140 using a slow scan 400 from a sentinel node or use walking backwards 900 to scan sequentially backwards from the identified location 624.

Once all the relevant pointers 314 have been identified, scan engine 150 may perform a record insertion as discussed next.

Turning now to FIG. 9B, a block diagram of a record insertion 950 is depicted. As shown, this may include scan engine 150 placing the previously pinned relevant pointers 314 into a new tower 300 in the inserted record 112 at location 624 so that the new record 112 points to same previously linked records 112 as the relevant pointers 314 in other records 112. As the new tower 300 obstructs the pointers 314 in other records 112, scan engine 150 may also update these pointers 314 to now point to the bucket identifier 312 of the inserted record 112 as shown in FIG. 9B.

Because record chains 110 and/or records 112 have the potential to be modified during walking backwards 900 and record insertion 950, scan engine 150 may also acquire latches 126 and/or locks 217 for records 112 determined to have relevant pointers 314 to prevent modifications during walking 900 and insertion 950. Once each of the relevant pointers 314 have been identified, scan engine 150 may further perform a verification of the pointers 314 before performing the record insertion 950 in order to ensure that a concurrent record modification or another record insertion has not interfered with record insertion 950.

As noted above, in various embodiments, scan engine 150 may also need to add or update one or more anchor entries 710 in response to the inserted record 112 becoming an initial record 112 for an anchor range 620 or having the new lowest key 212 for one or more anchor ranges 620.

Various methods that use one or more of the techniques discussed above will now be discussed.

Turning now to FIG. 10A, a flowchart of a method 1010 for fast skip list scanning is depicted. Method 1010 is one embodiment of a method performed by a computing system, such as database system 10, which may be executing scan engine 150. In some instances, performance of method 1010 may improve the performance of scanning a skip list.

In step 1015, a skip list (e.g., skip list 140) is stored including a plurality of key-value records (e.g., key-value records 112) that include one or more pointers (e.g., skip list pointers 218/314) to others of the plurality of key-value records. In some embodiments, the skip list maintains an ordering of keys for key-value records stored in a buffer data structure that stores data for active database transactions.

In step 1020, the skip list is scanned for a location (e.g., location 624) associated with a particular key.

In sub-step 1022, the scanning includes using a prefix (e.g., key prefix 610) of the particular key to identify a particular portion (e.g., anchor range 620) of the skip list where the particular portion includes key-value records having keys with the same prefix. In various embodiments, an index is maintained that associates key prefixes with key-value records in respective portions having the same key prefixes, and using the prefix includes accessing the index to identify an initial key-value record (e.g., anchor record 612) in the particular portion from where to initiate the scan. In some embodiments, accessing the index includes applying a hash function (e.g., hash function 122) to the prefix to identify a hash bucket (e.g., hash function 124) including a pointer (e.g., bucket identifier 312) to the initial key-value record in the particular portion and traversing (e.g., local traversal 810) the pointer to the initial key-value record in the particular portion. In some embodiments, a first prefix (e.g., shorter key prefix 610A) of the particular key and a second, longer prefix (e.g., longer key prefix 610B) are selected to determine whether relevant portions (e.g., wider and narrower anchor ranges 620A and 620B) of the skip list exists for the first and second prefixes and, in response to determining that a relevant portion does exist in the skip list for the second, longer prefix, selecting the portion relevant to the second prefix (e.g., narrower anchor range 620B) for use in the scan for the location. In some embodiments, a length of the prefix to be used is determined by accessing a set of anchor plans (e.g., anchor plans 650) that specify prefix lengths to be used based on a portion of the particular key.

In sub-step 1024, the scanning includes initiating a scan for the location within the identified portion. In various embodiments, the scan includes scanning forward (e.g., climbing the mountain 800) through the key-value records in the particular portion along the highest available pointers in skip list towers of the key-value records until a key-value record is identified that includes a pointer (e.g., in an overshooting tower 300 in FIG. 8) to another key-value record located after the location associated with the particular key in key order and traversing (e.g., local traversal 810) the skip list from the identified key-value record.

In some embodiments, method 1010 further includes inserting a key-value record (e.g., inserted record 112 in FIG. 9B) into the skip list at the location associated with the particular key in response to the scan identifying the location. In some embodiments, method 1010 further includes determining a set of pointers (e.g., for new tower 300 in FIG. 9B) to include in the key-value record being inserted by scanning sequentially backwards (e.g., walking backwards 900) from the identified location to identify key-value records that include pointers (e.g., relevant skip-list pointers 314 in FIG. 9A) that point to key-value records located after the identified location in key order. In some embodiments, prior to the scanning sequentially backwards, a number of pointers (e.g., a height of new tower 300) within the set is determined. Based on the determined number, a determination is made whether to traverse the skip list from a sentinel node (e.g., sentinel tower 300 in FIG. 4) or scan sequentially backwards from the identified location.

Turning now to FIG. 10B, a flowchart of another method 1030 for fast skip list scanning is depicted. Method 1030 is another embodiment of a method performed by a computing system, such as database system 10, which may be executing scan engine 150. In some instances, performance of method 1030 may reduce the burden of scanning a skip list.

In step 1035, a skip list (e.g., skip list 140) is stored that maintains an ordering of keys (e.g., keys 212) for key-value records (e.g., records 112) of a database (e.g., database 108). In various embodiments, the skip list maintains the ordering of keys for key-value records of database transactions awaiting commitment by the database.

In step 1040, a location (e.g., location 624) is determined within the skip list associated with a particular key. In sub-step 1042, the determining includes using a prefix (e.g., key prefix 610) of the particular key to identify a range (e.g., anchor range 620) within the skip list, where the range includes key-value records having keys with the same prefix. In sub-step 1044, the determining includes initiating a scan for the location within the identified range. In some embodiments, the determining includes scanning forward through the identified range until a key-value record is identified that includes a skip list tower (e.g., overshooting tower 300 in FIG. 8) with a pointer that overshoots the location and traversing the skip list (e.g., local traversal 810) from the skip list tower. In some embodiments, the determining includes, in response to determining the location, scanning sequentially backwards (e.g., walking backwards 900) from the location in the skip list to identify pointers (e.g., relevant skip-list pointers 218 in FIG. 9A) to be included in a tower (e.g., new tower 300 in FIG. 9B) of a key-value record being inserted into the skip list and inserting, at the determined location, the key-value record with the tower including the identified pointers. In some embodiments, the determining includes applying a hash function (e.g., hash function 122) to the prefix to index into a hash table (e.g., hash table 120) that includes a pointer (e.g., bucket identifier 312) to an initial key-value record (e.g., anchor record 622) in the range and initiating the scan from the initial key-value record in the range.

Turning now to FIG. 10C, a flowchart of a method 1060 for fast skip-list scanning is depicted. Method 1060 is another embodiment of a method performed by a computing system, such as database system 10, which may be executing scan engine 150. In some instances, performance of method 1060 may reduce the time taken to scan and/or insert records into a skip list.

In step 1065, a skip list (e.g., skip list 140) is maintained that preserves an ordering of keys (e.g., keys 212) for a plurality of key-value records (e.g., records 112). In some embodiments, a first of the plurality of key-value records in the skip list indirectly points to a second of the plurality of key-value records by including a first pointer (e.g., bucket identifier 312) to a bucket in a hash table (e.g., hash table 120), where the bucket includes a second pointer to the second key-value record.

In step 1070, the skip list is divided (e.g., key space partitioning 600) into sections (e.g., anchor ranges 620) based on prefixes (e.g., prefixes 610) of the keys. In some embodiments, the dividing includes maintaining a hash table (e.g., hash table 120) that associates the prefixes with pointers (e.g., anchor record bucket identifiers 312) to the sections within the skip list.

In step 1075, a location (e.g., location 624) associated with a particular key is determined, by initiating a scan for the location within a section corresponding to a prefix of the particular key. In various embodiments, the determining includes scanning (e.g., climbing up in FIG. 8) forward within the section until a key-value record is identified that includes a skip list tower (e.g., overshooting tower 300 in FIG. 8) with a pointer that points past the location and performing a skip list traversal (e.g., local traversal 810) from the identified key-value record to determine the location.

In some embodiments, method 1060 further includes scanning backwards (e.g., walking backwards 900) along a lowest level in the skip list to identify pointers to insert in a skip list tower (e.g., new tower 300 in FIG. 9B) for a key-value record being inserted into the skip list and inserting the key-value record with the skip list tower into the skip list.

### Exemplary Multi-Tenant Database System

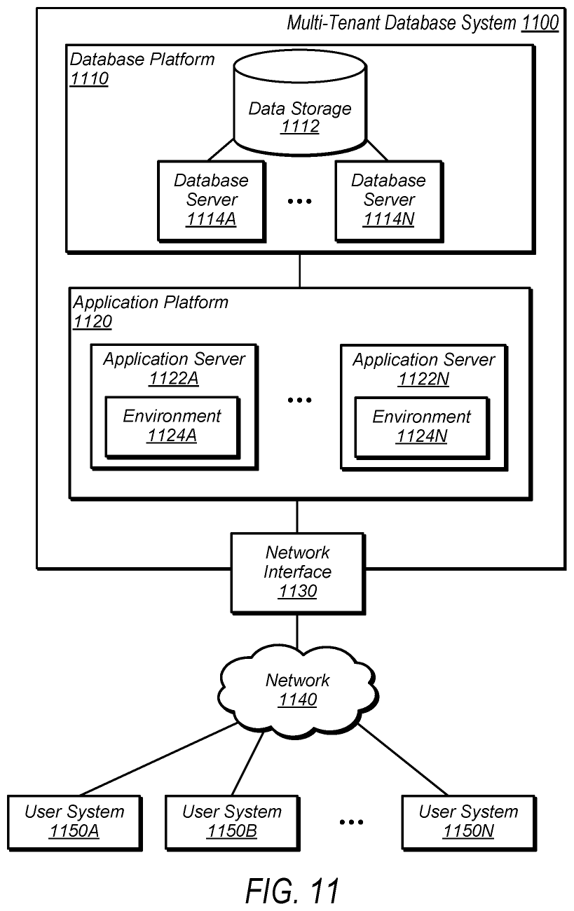

Turning now to FIG. 11, an exemplary multi-tenant database system (MTS) 1100, which may implement functionality of as database system 10, is depicted. In the illustrated embodiment, MTS 1100 includes a database platform 1110, an application platform 1120, and a network interface 1130 connected to a network 1140. Database platform 1110 includes a data storage 1112 and a set of database servers 1114A-N that interact with data storage 1112, and application platform 1120 includes a set of application servers 1122A-N having respective environments 1124. In the illustrated embodiment, MTS 1100 is connected to various user systems 1150A-N through network 1140. In other embodiments, techniques of this disclosure are implemented in non-multi-tenant environments such as client/server environments, cloud computing environments, clustered computers, etc.

MTS 1100, in various embodiments, is a set of computer systems that together provide various services to users (alternatively referred to as “tenants”) that interact with MTS 1100. In some embodiments, MTS 1100 implements a customer relationship management (CRM) system that provides mechanism for tenants (e.g., companies, government bodies, etc.) to manage their relationships and interactions with customers and potential customers. For example, MTS 1100 might enable tenants to store customer contact information (e.g., a customer's website, email address, telephone number, and social media data), identify sales opportunities, record service issues, and manage marketing campaigns. Furthermore, MTS 1100 may enable those tenants to identify how customers have been communicated with, what the customers have bought, when the customers last purchased items, and what the customers paid. To provide the services of a CRM system and/or other services, as shown, MTS 1100 includes a database platform 1110 and an application platform 1120.

Database platform 1110, in various embodiments, is a combination of hardware elements and software routines that implement database services for storing and managing data of MTS 1100, including tenant data. As shown, database platform 1110 includes data storage 1112. Data storage 1112, in various embodiments, includes a set of storage devices (e.g., solid state drives, hard disk drives, etc.) that are connected together on a network (e.g., a storage attached network (SAN)) and configured to redundantly store data to prevent data loss. In various embodiments, data storage 1112 is used to implement a database 108 comprising a collection of information that is organized in a way that allows for access, storage, and manipulation of the information. Data storage 1112 may implement a single database, a distributed database, a collection of distributed databases, a database with redundant online or offline backups or other redundancies, etc. As part of implementing the database, data storage 1112 may store one or more database records 112 having respective data payloads (e.g., values for fields of a database table) and metadata (e.g., a key value, timestamp, table identifier of the table associated with the record, tenant identifier of the tenant associated with the record, etc.).

In various embodiments, a database record 112 may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 1100 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, the data stored at data storage 1112 includes buffer data structure 106 and a persistent storage organized as part of a log-structured merge-tree (LSM tree). As noted above, a database server 1114 may initially write database records into a local in-memory buffer data structure 106 before later flushing those records to the persistent storage (e.g., in data storage 1112). As part of flushing database records, the database server 1114 may write the database records 112 into new files that are included in a “top” level of the LSM tree. Over time, the database records may be rewritten by database servers 1114 into new files included in lower levels as the database records are moved down the levels of the LSM tree. In various implementations, as database records age and are moved down the LSM tree, they are moved to slower and slower storage devices (e.g., from a solid state drive to a hard disk drive) of data storage 1112.

When a database server 1114 wishes to access a database record for a particular key, the database server 1114 may traverse the different levels of the LSM tree for files that potentially include a database record for that particular key 212. If the database server 1114 determines that a file may include a relevant database record, the database server 1114 may fetch the file from data storage 1112 into a memory of the database server 1114. The database server 1114 may then check the fetched file for a database record 112 having the particular key 212. In various embodiments, database records 112 are immutable once written to data storage 1112. Accordingly, if the database server 1114 wishes to modify the value of a row of a table (which may be identified from the accessed database record), the database server 1114 writes out a new database record 112 into buffer data structure 106, which is purged to the top level of the LSM tree. Over time, that database record 112 is merged down the levels of the LSM tree. Accordingly, the LSM tree may store various database records 112 for a database key 212 where the older database records 112 for that key 212 are located in lower levels of the LSM tree then newer database records.

Database servers 1114, in various embodiments, are hardware elements, software routines, or a combination thereof capable of providing database services, such as data storage, data retrieval, and/or data manipulation. Such database services may be provided by database servers 1114 to components (e.g., application servers 1122) within MTS 1100 and to components external to MTS 1100. As an example, a database server 1114 may receive a database transaction request from an application server 1122 that is requesting data to be written to or read from data storage 1112. The database transaction request may specify an SQL SELECT command to select one or more rows from one or more database tables. The contents of a row may be defined in a database record and thus database server 1114 may locate and return one or more database records that correspond to the selected one or more table rows. In various cases, the database transaction request may instruct database server 1114 to write one or more database records for the LSM tree—database servers 1114 maintain the LSM tree implemented on database platform 1110. In some embodiments, database servers 1114 implement a relational database management system (RDMS) or object oriented database management system (OODBMS) that facilitates storage and retrieval of information against data storage 1112. In various cases, database servers 1114 may communicate with each other to facilitate the processing of transactions. For example, database server 1114A may communicate with database server 1114N to determine if database server 1114N has written a database record into its in-memory buffer for a particular key.

Application platform 1120, in various embodiments, is a combination of hardware elements and software routines that implement and execute CRM software applications as well as provide related data, code, forms, web pages and other information to and from user systems 1150 and store related data, objects, web page content, and other tenant information via database platform 1110. In order to facilitate these services, in various embodiments, application platform 1120 communicates with database platform 1110 to store, access, and manipulate data. In some instances, application platform 1120 may communicate with database platform 1110 via different network connections. For example, one application server 1122 may be coupled via a local area network and another application server 1122 may be coupled via a direct network link. Transfer Control Protocol and Internet Protocol (TCP/IP) are exemplary protocols for communicating between application platform 1120 and database platform 1110, however, it will be apparent to those skilled in the art that other transport protocols may be used depending on the network interconnect used.

Application servers 1122, in various embodiments, are hardware elements, software routines, or a combination thereof capable of providing services of application platform 1120, including processing requests received from tenants of MTS 1100. Application servers 1122, in various embodiments, can spawn environments 1124 that are usable for various purposes, such as providing functionality for developers to develop, execute, and manage applications. Data may be transferred into an environment 1124 from another environment 1124 and/or from database platform 1110. In some cases, environments 1124 cannot access data from other environments 1124 unless such data is expressly shared. In some embodiments, multiple environments 1124 can be associated with a single tenant.

Application platform 1120 may provide user systems 1150 access to multiple, different hosted (standard and/or custom) applications, including a CRM application and/or applications developed by tenants. In various embodiments, application platform 1120 may manage creation of the applications, testing of the applications, storage of the applications into database objects at data storage 1112, execution of the applications in an environment 1124 (e.g., a virtual machine of a process space), or any combination thereof. In some embodiments, application platform 1120 may add and remove application servers 1122 from a server pool at any time for any reason, there may be no server affinity for a user and/or organization to a specific application server 1122. In some embodiments, an interface system (not shown) implementing a load balancing function (e.g., an F5 Big-IP load balancer) is located between the application servers 1122 and the user systems 1150 and is configured to distribute requests to the application servers 1122. In some embodiments, the load balancer uses a least connections algorithm to route user requests to the application servers 1122. Other examples of load balancing algorithms, such as are round robin and observed response time, also can be used. For example, in certain embodiments, three consecutive requests from the same user could hit three different servers 1122, and three requests from different users could hit the same server 1122.

In some embodiments, MTS 1100 provides security mechanisms, such as encryption, to keep each tenant's data separate unless the data is shared. If more than one server 1114 or 1122 is used, they may be located in close proximity to one another (e.g., in a server farm located in a single building or campus), or they may be distributed at locations remote from one another (e.g., one or more servers 1114 located in city A and one or more servers 1122 located in city B). Accordingly, MTS 1100 may include one or more logically and/or physically connected servers distributed locally or across one or more geographic locations.

One or more users (e.g., via user systems 1150) may interact with MTS 1100 via network 1140. User system 1150 may correspond to, for example, a tenant of MTS 1100, a provider (e.g., an administrator) of MTS 1100, or a third party. Each user system 1150 may be a desktop personal computer, workstation, laptop, PDA, cell phone, or any Wireless Access Protocol (WAP) enabled device or any other computing device capable of interfacing directly or indirectly to the Internet or other network connection. User system 1150 may include dedicated hardware configured to interface with MTS 1100 over network 1140. User system 1150 may execute a graphical user interface (GUI) corresponding to MTS 1100, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 1150 to access, process, and view information and pages available to it from MTS 1100 over network 1140. Each user system 1150 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 1100 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 1150 may be users in differing capacities, the capacity of a particular user system 1150 might be determined one or more permission levels associated with the current user. For example, when a salesperson is using a particular user system 1150 to interact with MTS 1100, that user system 1150 may have capacities (e.g., user privileges) allotted to that salesperson. But when an administrator is using the same user system 1150 to interact with MTS 1100, the user system 1150 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 1100 that are allocated at the tenant level while other data structures are managed at the user level.

In some embodiments, a user system 1150 and its components are configurable using applications, such as a browser, that include computer code executable on one or more processing elements. Similarly, in some embodiments, MTS 1100 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 1140 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 1150 may communicate with MTS 1100 using TCP/IP and, at a higher network level, use other common Internet protocols to communicate, such as HTTP, FTP, AFS, WAP, etc. For example, where HTTP is used, user system 1150 might include an HTTP client commonly referred to as a “browser” for sending and receiving HTTP messages from an HTTP server at MTS 1100. Such a server might be implemented as the sole network interface between MTS 1100 and network 1140, but other techniques might be used as well or instead. In some implementations, the interface between MTS 1100 and network 1140 includes load sharing functionality, such as round-robin HTTP request distributors to balance loads and distribute incoming HTTP requests evenly over a plurality of servers.

In various embodiments, user systems 1150 communicate with application servers 1122 to request and update system-level and tenant-level data from MTS 1100 that may require one or more queries to data storage 1112. In some embodiments, MTS 1100 automatically generates one or more SQL statements (the SQL query) designed to access the desired information. In some cases, user systems 1150 may generate requests having a specific format corresponding to at least a portion of MTS 1100. As an example, user systems 1150 may request to move data objects into a particular environment 1124 using an object notation that describes an object relationship mapping (e.g., a JavaScript object notation mapping) of the specified plurality of objects.

### Exemplary Computer System

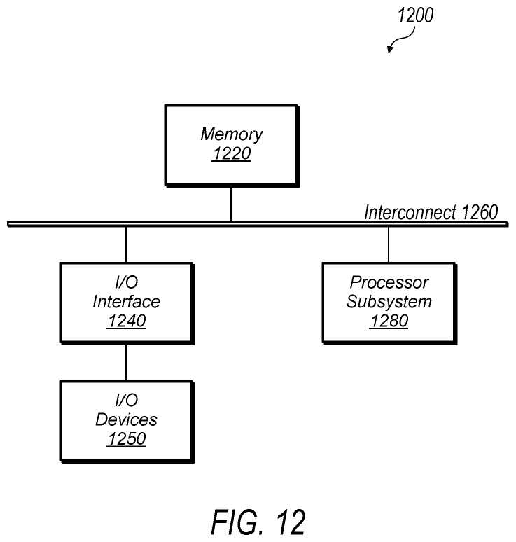

Turning now to FIG. 12, a block diagram of an exemplary computer system 1200, which may implement functionality described herein, such as database system 10, a portion of database system 10, or a client interacting with database system 10, is depicted. Computer system 1200 includes a processor subsystem 1280 that is coupled to a system memory 1220 and I/O interfaces(s) 1240 via an interconnect 1260 (e.g., a system bus). I/O interface(s) 1240 is coupled to one or more I/O devices 1250. Computer system 1200 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1200 is shown in FIG. 12 for convenience, system 1200 may also be implemented as two or more computer systems operating together in a cluster.

Processor subsystem 1280 may include one or more processors or processing units. In various embodiments of computer system 1200, multiple instances of processor subsystem 1280 may be coupled to interconnect 1260. In various embodiments, processor subsystem 1280 (or each processor unit within 1280) may contain a cache or other form of on-board memory.

System memory 1220 is usable store program instructions executable by processor subsystem 1280 to cause system 1200 perform various operations described herein. System memory 1220 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 1200 is not limited to primary storage such as memory 1220. Rather, computer system 1200 may also include other forms of storage such as cache memory in processor subsystem 1280 and secondary storage on I/O Devices 1250 (e.g., a hard drive, storage array, etc.). In some embodiments, these other forms of storage may also store program instructions executable by processor subsystem 1280 to cause system 1200 to perform operations described herein. In some embodiments, memory 1220 may include transaction manager 104, scan engine 150, buffer data structure 106, and/or portions of database 108.

I/O interfaces 1240 may be any of various types of interfaces configured to couple to and communicate with other devices, according to various embodiments. In one embodiment, I/O interface 1240 is a bridge chip (e.g., Southbridge) from a front-side to one or more back-side buses. I/O interfaces 1240 may be coupled to one or more I/O devices 1250 via one or more corresponding buses or other interfaces. Examples of I/O devices 1250 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1200 is coupled to a network via a network interface device 1250 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A non-transitory computer readable medium having program instructions stored thereon that are capable of causing a computing system to implement operations comprising:
storing a skip list including a plurality of key-value records that include one or more pointers to others of the plurality of key-value records;
scanning the skip list for a location associated with a particular key, wherein the scanning includes:
using a prefix of the particular key to identify a particular portion of the skip list, wherein the particular portion includes key-value records having keys with the same prefix; and
initiating a scan for the location within the identified portion.

2. The computer readable medium of claim 1, wherein the scan includes:
scanning forward through the key-value records in the particular portion along the highest available pointers in skip list towers of the key-value records until a key-value record is identified that includes a pointer to another key-value record located after the location associated with the particular key in key order; and
traversing the skip list from the identified key-value record.

3. The computer readable medium of claim 1, wherein the operations further comprise:
inserting a key-value record into the skip list at the location associated with the particular key in response to the scan identifying the location.

4. The computer readable medium of claim 3, wherein the operations further comprise:
determining a set of pointers to include in the key-value record being inserted by scanning sequentially backwards from the identified location to identify key-value records that include pointers that point to key-value records located after the identified location in key order.

5. The computer readable medium of claim 4, wherein the operations further comprise:
prior to the scanning sequentially backwards, determine a number of pointers within the set; and
based on the determined number, determining whether to traverse the skip list from a sentinel node or scan sequentially backwards from the identified location.

6. The computer readable medium of claim 1, wherein the operations further comprise:
maintaining an index that associates key prefixes with key-value records in respective portions having the same key prefixes; and
wherein using the prefix includes:
accessing the index to identify an initial key-value record in the particular portion from where to initiate the scan.

7. The computer readable medium of claim 6, wherein the index is a hash table; and
wherein accessing the index includes:
applying a hash function to the prefix to identify a hash bucket including a pointer to the initial key-value record in the particular portion; and
traversing the pointer to the initial key-value record in the particular portion.

8. The computer readable medium of claim 1, wherein the scanning includes:
selecting a first prefix of the particular key and a second prefix of the particular key to determine whether relevant portions of the skip list exist for the first and second prefixes, wherein the second prefix is longer than the first prefix; and
in response to determining that a relevant portion does exist in the skip list for the second, longer prefix, selecting the portion relevant to the second prefix for use in the scan for the location.

9. The computer readable medium of claim 1, wherein the operations further comprise:
determining a length of the prefix to be used by accessing a set of anchor plans, wherein the anchor plans specify prefix lengths to be used based on a portion of the particular key.

10. The computer readable medium of claim 1, wherein the skip list maintains an ordering of keys for key-value records stored in a buffer data structure that stores data for active database transactions.

11. A method, comprising:
storing, by a computing system, a skip list that maintains an ordering of keys for key-value records of a database;
determining, by the computing system, a location within the skip list associated with a particular key, wherein the determining includes:
using a prefix of the particular key to identify a range within the skip list, wherein the range includes key-value records having keys with the same prefix; and
initiating a scan for the location within the identified range.

12. The method of claim 11, wherein the determining:
scanning, by the computing system, forward through the identified range until a key-value record is identified that includes a skip list tower with a pointer that overshoots the location; and
traversing, by the computing system, the skip list from the skip list tower.

13. The method of claim 11, further comprising:
in response to determining the location:
scanning, by the computing system, sequentially backwards from the location in the skip list to identify pointers to be included in a tower of a key-value record being inserted into the skip list; and
inserting, by the computing system at the determined location, the key-value record with the tower including the identified pointers.

14. The method of claim 13, wherein the determining includes:
applying a hash function to the prefix to index into a hash table that includes a pointer to an initial key-value record in the range; and
initiating the scan from the initial key-value record in the range.

15. The method of claim 11, wherein the skip list maintains the ordering of keys for key-value records of database transactions awaiting commitment by the database.

16. A computing system, comprising:
one or more processors; and
memory having program instructions stored thereon that are capable of causing the computing system to implement operations comprising:
maintaining a skip list that preserves an ordering of keys for a plurality of key-value records;
dividing the skip list into sections based on prefixes of the keys; and
determining a location associated with a particular key, by initiating a scan for the location within a section corresponding to a prefix of the particular key.

17. The computing system of claim 16, wherein the dividing includes:
maintaining a hash table that associates the prefixes with pointers to the sections within the skip list.

18. The computing system of claim 16, wherein the determining includes:
scanning forward within the section until a key-value record is identified that includes a skip list tower with a pointer that points past the location; and
performing a skip list traversal from the identified key-value record to determine the location.

19. The computing system of claim 16, wherein the operations further comprising:
scanning backwards along a lowest level in the skip list to identify pointers to insert in a skip list tower for a key-value record being inserted into the skip list; and
inserting the key-value record with the skip list tower into the skip list.

20. The computing system of claim 16, wherein a first of the plurality of key-value records in the skip list indirectly points to a second of the plurality of key-value records by including a first pointer to a bucket in a hash table, wherein the bucket includes a second pointer to the second key-value record.
